(19) United States
(12) Patent Application Publication
(10) Pub. No.: US 2007/0049245 A1
(43) Pub. Date: Mar. 1, 2007

(54) Cellular-internet communication system and method

(76) Inventor: Steve B. Lipman, Sherman Oaks, CA (US)

Correspondence Address: ALLAN M. SHAPIRO, 18401 BURBANK BIVD., SUITE 202, TARZANA, CA, 91356, US

(21) Appl. No.: 11/210,850

(22) Filed: Aug. 25, 2005

(51) Int. Cl. H04M 11/04; H04M 11/00

(52) U.S. Cl. 455/406; 455/404.1

(57) ABSTRACT

A cellular-Internet (CellNet) communications system, and a corresponding method, provides routing between a cellular telephone-originated call and Voice over Internet Protocol (VoIP). The system includes a cellular-Internet switch, where cellular-originated telephone calls are received, the switch routing a cellular call as a VoIP call and an authentication device, where a cellular telephone is assigned an authentication number, and the authentication device provides for billing a user for the VoIP call. Finally, the system includes a billing system, where time spent on the VoIP call is received and the user is billed.

### TECHNICAL FIELD

The technical field is cellular communications using the Internet.

### BACKGROUND

The use of mobile telephony has transformed the way people communicate and businesses operate. One aspect of this mobile telephony transformation is the use of cellular telephones, which first came into use in the late 1970s. More recent transformations include wireless fidelity (Wi-Fi) technology, and voice over Internet Protocol (VoIP). However, both of these technologies come with restrictions on their use. Wi-Fi has only a limited range, typically less than three hundred feet. VoIP is not available for cellular phones. In fact, a specific VoIP phone is required to place VoIP calls. In addition, VoIP calls require much more time for connection than do ordinary calls.

### SUMMARY

What is disclosed is cellular-Internet (CellNet) communications system, comprising a cellular-Internet switch, wherein cellular-originated telephone calls are received, the switch comprising means for routing a received call as a Voice over Internet Protocol (VoIP) call; an authentication device, wherein a cellular telephone is assigned an authentication number, the authentication device providing means for billing a user for the VoIP call; and a billing system, wherein time spent on the VoIP call is received and the user is billed.

Also disclosed is a cellular-Internet communications system, comprising means for receiving a cellular telephone call and converting the received cellular telephone call to a packetized signal capable of transmission over the Internet as a VoIP call; means coupled to the receiving and converting means for authentication the received cellular telephone call; and means for billing a user for the VoIP call.

Still further what is disclosed is a method for placing a Voice over Internet Protocol (VoIP) call, comprising receiving a cellular-originated telephone call; receiving an authentication number from a user making the cellular-originated telephone call; verifying the authentication number, and if the authentication number is verified; and routing the cellular-originated telephone call as a VoIP call and transmitting the VoIP call to a destination address.

Yet further, what is disclosed is a cellular-Internet communications system, comprising means for receiving a cellular telephone call and converting the received cellular telephone call to a packetized signal capable of transmission over the Internet as a VoIP call; means for authenticating the received cellular telephone call; and means for billing a user for the VoIP call.

### DESCRIPTION OF THE DRAWINGS

The detailed description will refer to the following drawings, in which like numerals refer to like items, and in which:

FIG. 1A is a block diagram of an embodiment of a cellular-Internet (CellNet) system;

FIG. 1B is a block diagram of an alternate embodiment of the CellNet system;

FIG. 2 is a block diagram of selected components of an authentication device used with the CellNet system of FIG. 1A

FIG. 3 is a architectural diagram of a switch/gateway used with the CellNet system of FIGS. 1A and 1B;

FIG. 4 is a block diagram of a billing module used with the switch of FIGS. 1A and 1B;

FIG. 5 is a block diagram of an authentication module used with the switch of FIGS. 1A and 1B;

FIGS. 6A and 6B illustrate a flowchart of a call connection routine using the CellNet system of FIGS. 1A and 1B; and

FIG. 7 is a flowchart illustrating an emergency call processing routine at the switch of FIGS. 1A and 1B.

### DETAILED DESCRIPTION

Wireless fidelity (Wi-Fi) refers to a certain type of wireless local area network (WLAN). Wi-Fi uses the airwave spectrum that has not been auctioned or allocated to an exclusive user, and is the same spectrum used by wireless phones and microwave ovens. Wi-Fi communications follow the Institute of Electrical and Electronics Engineers (IEEE) 802.11 standards. IEEE first approved standard 802.11b in 1999. In standard 802.11b, data transfer occurs at 11 Mbps at frequencies of 2.4-2.497 GHz. (a typical home cable connection transfers data at 3-10 Mbps.) Standard 802.11g was approved in June 2003, with speeds up to 54 Mbps and is backwards compatible with standard 802.11b. Both standards 802.11b and g are limited to three non-overlapping channels. However, standard 802.11a, also approved in July, 1999, offers up to twelve non-overlapping channels operating at a higher frequency, 5-6 GHz, to avoid interference with microwaves and popular short-range devices, such as those equipped with Bluetooth technology. Unfortunately, standard 802.11a is not compatible with b or g technology and is not yet approved in Europe. Wi-Fi technology continues to evolve as semiconductor companies and equipment firms are already working on a new Wi-Fi standard, 802.11n, which will more than double the data transmission speed of 802.11g.

The key component in a Wi-Fi network is the access point, typically a combined access point and router, which connects directly to a cable or DSL modem. Additional network components such as a printer or scanner can be plugged in to the access point. Each component that connects to the Wi-Fi network needs its own wireless adapter. Many notebook computers now come with a wireless adapter built in.

Many airports, hotels and other facilities offer public access to Wi-Fi networks. These locations are known as hot spots. Typically a daily or hourly rate is charged for access. An interconnected area of hot spots and network access points is known as a hot zone. However, Wi-Fi works only in a limited range—usually 100-300 feet and thus is not available outside the hot spots.

VoIP technology allows users to make telephone calls over the Internet using a broadband connection. A standard phone is plugged into a VoIP modem, which can be plugged into a standard high-speed cable modem. VoIP technology takes telephone calls and turns them into digital files, which are broken into packets of data, sent over the Internet, reassembled, and then converted back to voice calls on the other end, similar to how e-mail is sent over the Internet. The advantage of VoIP technology is that a user no longer needs a separate telephone line to make a telephone call if a broadband connection is already in place.

One limitation of VoIP is the need for secure and high-speed Web access, they can basically work from anywhere. Basically, the VoIP telephone works if directly wired with an Ethernet connection or if the VoIP telephone is operated at a hot spot. This lack of mobility is a significant disadvantage to current VoIP telephony.

A limitation to use of VoIP centers around the current need to navigate multiple authentication systems commonly used by laptop computers on a wireless network. This can take several minutes to complete, which may not be acceptable to the average person used to receiving an immediate connection upon dialing his phone. This same authentication process presents obstacles to seamless transfer of calls from one wireless network to another if the consumer is mobile during a call. Today, the call would be dropped as soon as the user moved out of range of the initial access point (AP). Finally, powering a combined cellular/Wi-Fi device presents another challenge since Wi-Fi consumes much more power than cellular technology. With current technology there is a trade off between an acceptable size and weight of a battery and its ability to maintain a charge.

Another wireless protocol is termed WiMAX, which stands for Worldwide Interoperability for Microwave Access. WiMAX is not yet deployed, but WiMAX standards are provided in IEEE 802.16. Basically, WiMAX is intended to be a wireless metropolitan area network (MAN) technology that can connect Wi-Fi hotspots to the Internet and provide a wireless extension to cable and DSL broadband access. IEEE standard 802.16 provides up to 50 km (31 miles) of linear service area range and allows users connectivity without a direct line of sight to a base station. The technology also provides shared data rates up to 70 Mbps. WiMAX is expected to allow interpenetration for broadband service provision of VoIP, video and internet access—simultaneously. Tin addition, WiMAX antennas can “share” a cell tower without compromising the function of cellular arrays already in place. Companies that already lease cell sites in widespread service areas have a unique opportunity to diversify—and often already have the necessary spectrum available to them (i.e., they own the licenses for radio frequencies important to the speed and/or range of the WiMAX connection). WiMAX antennae would be connected to a service provider's head end via either a light fiber optics cable or a directional microwave link. Some cellular companies are evaluating WiMAX as a means of increasing bandwidth for a variety of data-intensive applications.

Cellular telephone users would like the convenience and low cost of telephone services normally experienced only by customers who employ VoIP telephony devices to communicate voice messages over the Internet, but do not want the mobility restriction of current VoIP telephony. Furthermore, a significant obstacle to such functionality is the inability to accurately bill cellular telephone users for VoIP services (hereafter, a VoIP-cellular user). Associated with this obstacle is the difficult nature of authenticating a VoIP-cellular user.

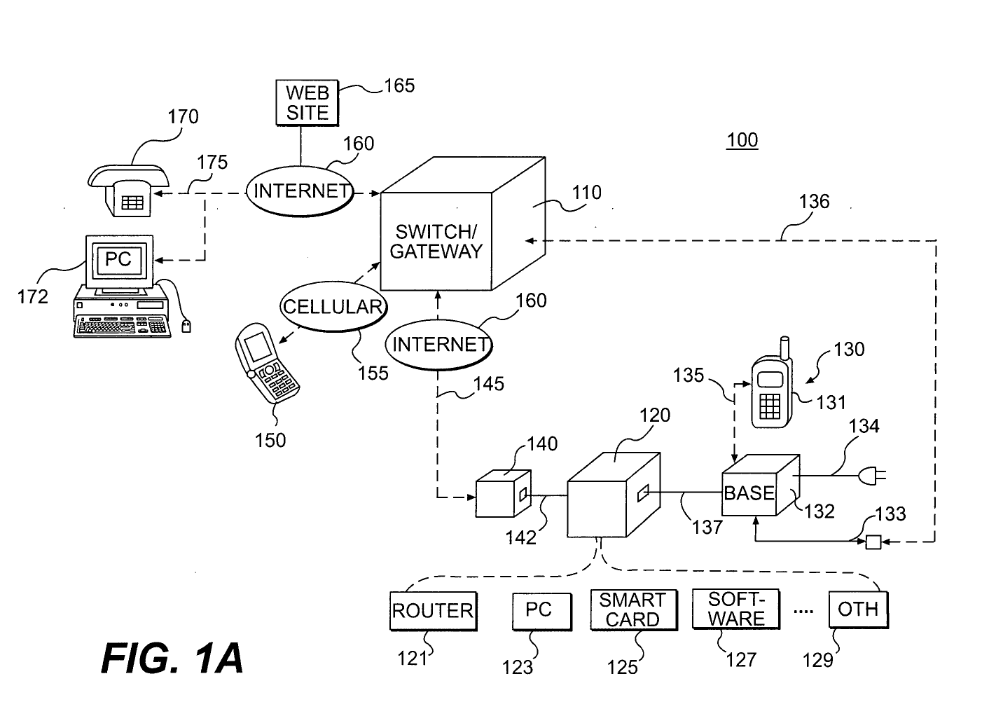

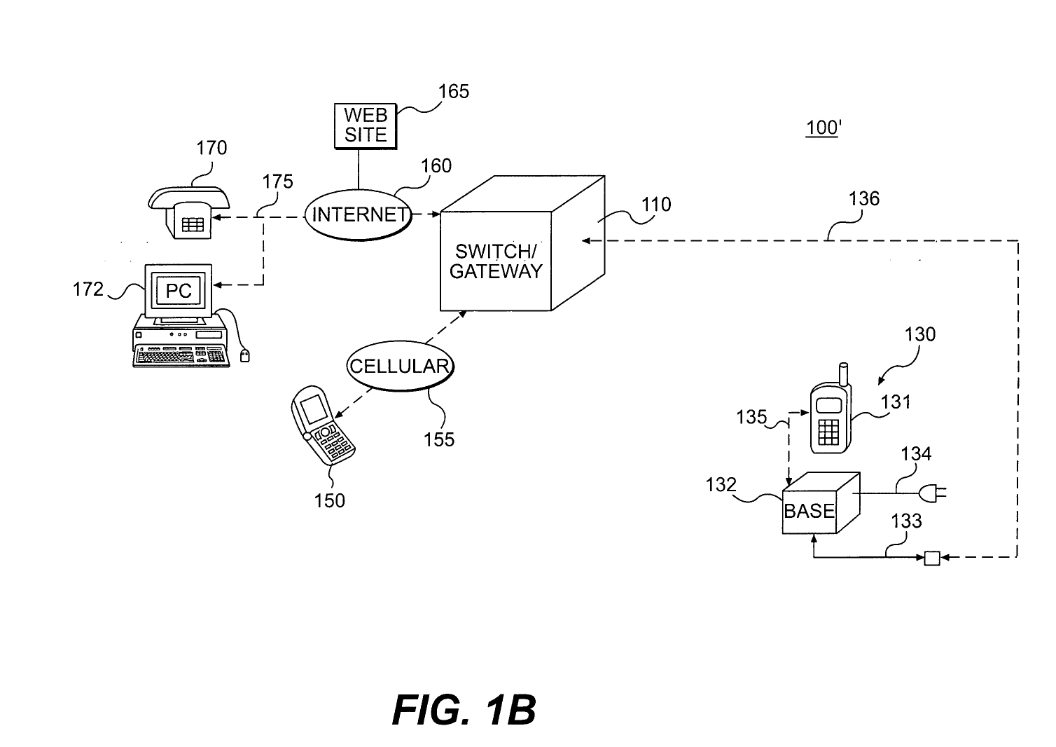

To overcome these authentication problems, and to provide cellular telephone users with the benefit of low-cost and fully mobile Internet telephony, a cellular-Internet (CellNet) system is provided, an embodiment of which is shown in FIG. 1A. In FIG. 1A, CellNet system 100 includes a remote switch, or gateway 110. Although FIG. 1A shows only a single switch 110, the CellNet system 100 may use more than one geographically dispersed switches 110.

In communication with the switch 110 is mobile (i.e., cordless) telephone 130. The mobile telephone 130 includes handset 131, which is insertable into base 132. The base 132 provides battery charging for the handset 131 using power cord 134. In one embodiment, the base 132 is connected to a telephone network, such as the PSTN (not shown) using standard phone wire connection 133. In operation, the base 132 receives an incoming telephone call, as an electrical signal through the connection 133, converts the call to an FM radio signal 135, and then broadcasts the FM signal 135 to the handset 131. Outgoing calls from the handset 131 reverse the process.

In another embodiment, the base 132 connects to the switch 110 only through Ethernet cable 137, and all telephony between the switch 110 and the mobile telephone 130 is conducted over this path. In this later embodiment, the mobile telephone 130 also may connect to the PSTN (not shown) at connection 133 for telephone call that are not routed through the switch 110 (i.e., for non-VoIP calls).

In still another embodiment, the mobile telephone 130 connects to the switch 110 through PSTN 136, and all call to the switch 110 from the mobile telephone 130 are made over the PSTN 136. As will be described later, calls from the mobile telephone 130 to the switch 110 over the PSTN 136 may be converted to VoIP at the switch 110. Alternatively, the conversion to VoIP may occur at authentication device 120.

In an embodiment, the base 132 may incorporate some or all of the features of a combined charging device and wireless server disclosed in co-pending patent application entitled MOBILE PHONE CHARGING BASE AND WIRELESS SERVER, application Ser. No. 11/182,856, filed on Jul. 18, 2005, the disclosure of which is hereby incorporated by reference. The handset 131 receives the FM signal 135 from the base 132, converts the FM signal 135 into an electrical signal, and sends the electrical signal to a speaker on the handset 131. The handset 131 and the base 132 operate on a frequency pair that allows a user to talk and listen at the same time. The mobile telephone 130 may be any standard mobile telephone operating, for example, in the 900 MHz, 2.4 GHz, or 5.8 GHz ranges.

Although not shown in FIG. 1A, the CellNet system 100 can accommodate other means for voice communication including a standard wired telephone and a computer with a speaker and microphone, for example. These later devices physically may reside at any location, including the same location as the mobile telephone 130, or at a location remote from the mobile telephone 130, such as at a hotel room, for example.

Returning to the mobile telephone 130, the base 132 is coupled to authentication device 120 using Ethernet cable 137, or a similar high-speed connection device. The authentication device 120 will be described in more detail below. The authentication device 120 is coupled to a high-speed connection device 140, such as a DSL modem or cable modem, for example, using Ethernet connection 142. The high-speed connection device 140 is then connected by communications path 145, through the Internet 160 to the switch 110.

The authentication device 120 includes logic to register a user of the CellNet system 100, and to provide certain authentication and billing functions, which will be described later in more detail. In an embodiment, the authentication device 120 may incorporate means for converting a standard telephone call (i.e., a non-VoIP call) into a VoIP call for transmission to the switch 110. In one embodiment, the authentication device 120 is a standalone “black box.” In other embodiments, as shown in FIG. 1A, the authentication device 120 may be a hardware component incorporated into a router 121 or a personal computer 123, a smart card 125, which can be inserted into a number of different electronic devices, software 127, which may be used to program a suitable processor (not shown), or other hardware and/or software 129. In an embodiment, the authentication device 120 may be incorporated (as hardware, software, or a combination of the two) into the mobile telephone base 132.

Also shown connected to the switch 110, though cellular network 155, is cellular telephone 150. Normally, a user of the cellular telephone 150 will also own, or be a user of, the mobile telephone 130. Thus, in the CellNet system 100, the user first installs the authentication device 120 at the user's residence, place of business, or other suitable locale. The user is then provided with a toll-free telephone number to connect to the switch 110. The user is also provided with an authentication number, which can be entered using either the mobile telephone 130 or the cellular telephone 150. Using the toll-free number and the authentication number, the user can place a call to the switch 110, pass an authentication routine, and be connected, through the Internet 160, to other communications devices, such as a standard telephone 170 or a personal computer 172, or to a Web site 165. In essence, the switch 110 allows the user to make a VoIP call using the mobile telephone 130, the cellular telephone 150, or other devices capable of voice communications. The addition of the authentication device 120 in the CellNet system 100 provides operators of the switch 110 with an optional mechanism to charge the user for the VoIP call and to register the user for this VoIP service.

With the CellNet system 100, the user can receive the benefit of much lower cost VoIP telephony (as compared to telephone calls using the PSTN or a cellular network) while the switch operators have a reliable and accurate means for billing the user for the VoIP call. The user also can take advantage of the CellNet system 100 using different calling plans. First, the user can pre-pay for calls by, for example, establishing a credit at the switch 110. The CellNet system 100 can accommodate several different prepaid calling plans. Second, the user can access the CellNet services by paying a one-time base fee and a periodic (e.g., monthly) subscription. The periodic subscription can provide for a set number of VoIP calling minutes, and any overages are then charged to the user. Third, the user can adopt a pay-as-you-go plan, where the user receives a periodic bill or statement for access to the CellNet system 100. The pay-as-you-go plan may include a base fee for access to the CellNet system 100.

In operation, the user, when using the mobile telephone 130, simply calls the toll-free number of the switch 110. The user is then, through a voice, tone, text, iconic, or graphic message, prompted to enter the user's authentication number, as optionally provided with installation of the authentication device 120. For example, the user may dial the toll-free number and receive a “*” icon from the switch 110 in return. The “*” icon acts as a prompt to the user to enter the user's authentication number. In an embodiment, as described later in detail, the user could also enter an emergency call number (e.g., 911 in the United States) following the “*” prompt, and the switch 110 would initiate an emergency call procedure.

Following entry of the authentication number, an authentication component in the switch 110 verifies the identity of the user, and other processors, described below, verify the status of the user's account. Once these preliminary steps are completed, the user is prompted to enter the phone number, or Web address of the call recipient, and the switch 110 completes call initiation and connection routines. The user is then able to call anywhere serviced by the switch 110, over the Internet (i.e., VoIP), including international calls, and the rate for the call will be much lower than traditional long-distance calling.

When the user is at a location remote from the mobile telephone 130 (i.e., sufficiently far from the base 132 that the mobile telephone handset 131 will not operate), the user still has the option of low-cost VoIP service through the switch 110 by using the cellular telephone 150. Again, the user simply dials the toll-free number for the switch 110, enters the user's authentication number, and then enters the number of the call recipient. The call from the cellular telephone to the switch 110 is made over the cellular network 155, but the connection from the switch 110 to the call recipient is made over the Internet 160 (i.e., from the switch 110 to the call recipient).

When using the cellular telephone 150 to make a VoIP call using the switch 110, an additional verification routine may be implemented to ensure that the authentication device 120 is connected, and that the user can be billed for the VoIP call. Specifically, when the switch 110 receives a call from the cellular telephone 150, processors with the switch 110 may generate and send a verification signal to the user's authentication device 120. Upon receiving a return signal from the authentication device 120, the switch 110 proceeds with call connection.

In an alternative to embodiment of the CellNet system 100 shown in FIG. 1A, the authentication device 120 is not installed. Instead, other authentication means are provided. FIG. 1B shows an alternative CellNet system 100′, in which the mobile telephone 130 connects to the switch 110 using the normal telephone path 136, only. In addition, the cellular telephone 150 connects to the switch 110 by way of the cellular network 155.

In the CellNet system 100′, the authentication means includes a pre-arranged service contract between the user and the operator of the switch 110. For example, the user could purchase a prepaid calling plan, and would then be given a toll-free call-in number and an authentication number, both of which would serve the same function as in the CellNet system 100. The user could then connect to the switch 110 using either the mobile telephone 130, the cellular telephone 150, or other voice-capable devices, and receive the benefit of VoIP telephony from the switch 110 to the call recipient, as long as the user maintains an adequate prepaid calling plan account balance.

Although not shown in FIG. 1B, the CellNet system 100′ can accommodate other means for voice communication including a standard wired telephone and a computer with a speaker and microphone, for example. The CellNet system 100′ also can accommodate other calling plans besides prepaid calling plans, including pay-as-you go calling plans that involve periodic invoicing for VoIP services. With non-prepaid calling plans, the user still is provided with authentication means, such as the toll-free number and an authentication number.

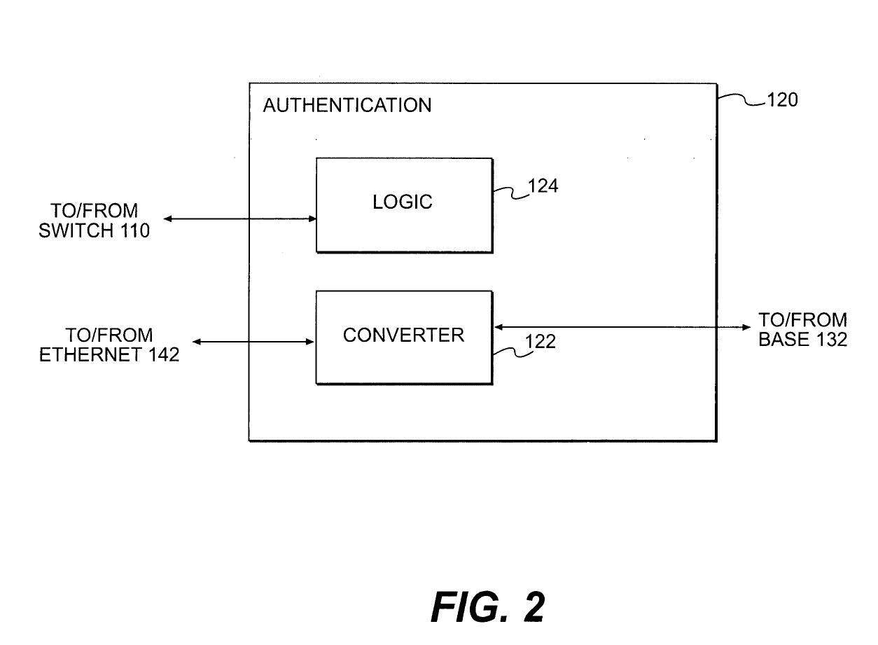

FIG. 2 is a block diagram of an embodiment of the authentication device 120 showing selected components. The authentication device 120 includes logic 124 to verify connectivity to the switch 110 and optional converter 122 to convert the telephone signal generated by the base 132 of the mobile telephone 130 into a digital, packetized signal that can be sent over Ethernet connection 142 and the Internet 160 to the switch 110.

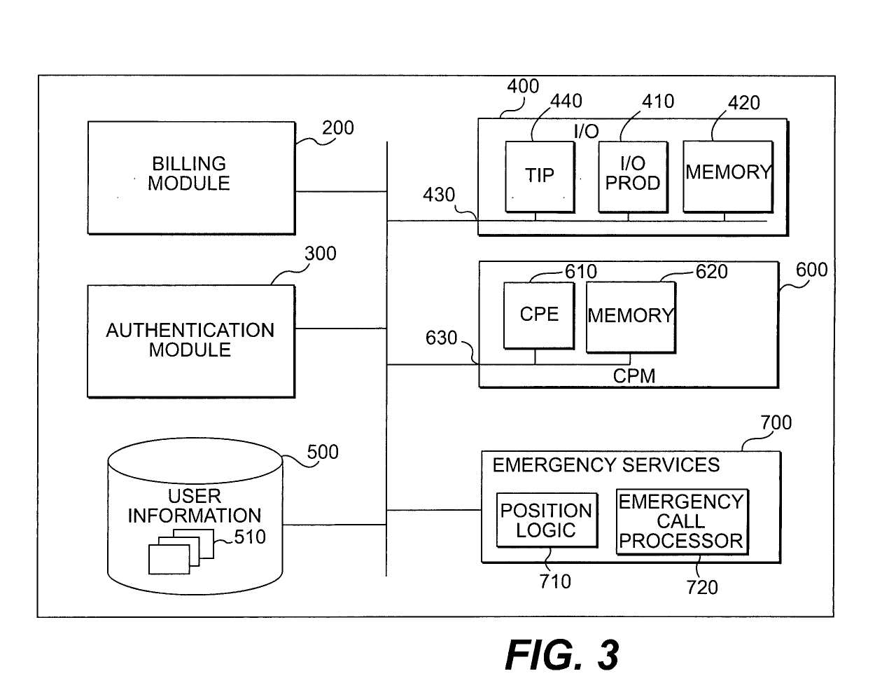

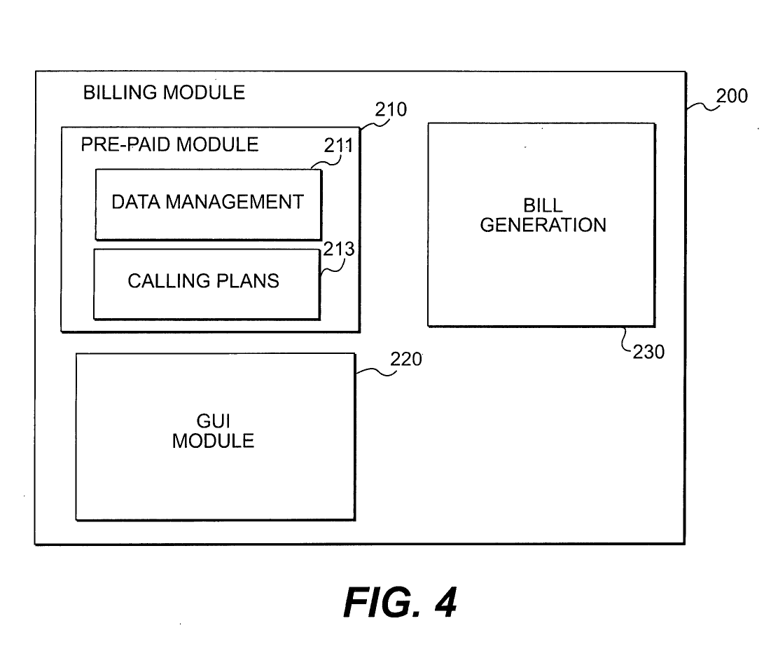

FIG. 3 is a block diagram of selected components of the switch 110. The switch 110 is shown to include a billing module 200, an authentication module 300, an I/O processor module 400, caller information database 500, which contains a user profile 510 for each user of the CellNet system 100, a call processing module (CPM) 600, and an emergency call processing module 700.

The I/O processor module 400 includes I/O processors 410, memory 420, and connector 430 that couples the I/O processor module 400 to other components of the switch 110. The memory 420 includes random access memory (RAM) and read only memory (ROM). The memory 420 stores application programs needed to operate the I/O module 400. The I/O processor module 400 also includes telephony interface processors 440 that receive telephony from different sources, including the PSTN, cellular network 155, and the Internet 160. The I/O processor 400 optionally includes telephony interface processors 440 for each cellular protocol. With the optional telephony interface processors 440, the switch 110 is capable of receiving cellular telephone calls in any format or protocol and converting the received cellular telephone call into a VoIP call. When the telephony interface processors 440 are not present, the conversion of the cellular telephone call to VoIP may occur at a location external to the switch 110. IN any event, call originating as cellular telephone calls (referred to as cellular-originated calls) are converted to VoIP at some point between the cellular telephone 150 and the switch 110, or at the switch 110. Thus, any suitable wireless access system may be used with the I/O processor 400, e.g., Frequency Division Multiple Access (FDMA), Code Division Multiple Access (CDMA), Time Division Multiple Access (TDMA), Time Division Duplex (TDD), Orthogonal Frequency Multiple Access (OFDMA) or combinations of these such as CDMA/FDMA, CDMA/FDMA/TDMA, FDMA/TDMA, and the switch 110 is able to communicate with any cellular telephone, regardless of its protocol.

Within the user database 500, each of the user profiles 510 contain information related to the user's selected calling plan, equipment configuration, and authentication number. How the switch 110 uses this information will be described in detail later. The information contained in the user profile 510 may be entered by the user by accessing a Web page of the CellNet system 100, or by manual entry by a switch operator using a graphical user interface (GUI).

The CPM 600 includes a central processing element 610, memory 620, and connector 630 that couples the CPM 600 to other components of the switch 110. The memory 620 includes RAM and ROM. The memory 620 stores application programs needed to operate the CPM 600. The central processing element 610 executes the stored application programs. The functions of the CPM 600 will be described in more detail later.

The emergency services module 700 includes position location logic 710, which is used to receive or determine an approximate position of the user. The emergency services module 700 also includes an emergency call processor, which controls the execution of an emergency call within the CellNet system 100, and performs routines as needed to connect the user to an appropriate emergency service provider.

FIG. 3 is a block diagram of the billing module 200. The billing module 200 includes prepaid module 210, graphical user interface (GUI) module 220, and bill generation module 230. The prepaid module 210 includes a data management module 211 and rate plans 213. Each user can select one of several different rate plans in the CellNet system 100. The GUI module 220 provides GUIs that allow the user or the switch operator to select call features, such as a prepaid calling plan, and to view calling plan account status, for example.

Within each user profile 510 in the caller information database 500, the parameter for prepaid service is configured as prepaid or not. The prepaid configuration of the user may be controlled by a prepaid check box and associated prepaid window generated by the graphical user interface module 220. The window is used to define the user's rate plan for the prepaid service. Also, the credited amount for the account is input with the prepaid data. This field tracks the amount of service that a user is allowed on the CellNet system 100. The amount is updated in real-time to track the usage of the CellNet system 100 by the user.

Another part of the prepaid system is bill generation, which is integrated as part of a call record management subsystem. The set of functions available allows a CellNet system operator the ability to create a range of reports based on operator defined billing cycles.

In operation, when a user who has elected a prepaid calling plan uses the CellNet system 100, the user profile 510 is pulled from the database 500 to determine the applicable user rate plan. The information from the user profile 510 is passed to the CPM 600. The CPM 600 determines if the user has an account balance sufficient to pay for the call. The CPM 600 also determines the least cost route for the call, if applicable, including any charges associated with the destination and time of day of the call to come up with the per minute charge. This value is then used to set a timer within the CPM 600 that will indicate when the user's account reaches a balance that corresponds to a preset time (e.g., two minutes) left on a call.

Once the prepaid call has begun, the timer begins a time out process and when the preset time position is reached, the CPM 600 provides a visual (e.g., text) and/or tone warning to the user indicating that the user is running out of money left in the user's prepaid account. No further warnings are provided, and once the remaining time has expired, the timer sends a message to the central processing element 610 indicating that the time has expired. The CPM 600 then initiates a call cutoff, terminating the prepaid call. In this way, the user cannot overrun the prepaid account balance.

At the completion of the call, the bill generation module 230 calculates how much the call actually cost for the user and updates the amount in the database 500. A call detail record (CDR) is prepared that provides the detailed information regarding the call so that the bill generation module 230 can determine the remaining account balance. The bill generated by the bill generation 230 is then used to update the user profile 510.

When the user has elected a prepaid calling plan, the data management module may prepare a text or voice message to send to the user's cellular telephone 150 and/or the user's mobile telephone 130 warning the user when the user's prepaid account balance reaches a specified minimum level. In this way, the user can take action to keep the account balance high enough to permit unimpeded VoIP calling.

If the user has not elected to use a prepaid calling plan, then the timer in the CPM 600 simply records the time on the call and provides this information to the data management module 211. The data management module 211 then computes the total time charges and any other charges for the call and provides the charge information to the bill generation module 230. The bill generation module 230 prepares the call detail record and stores the call detail record in memory until a periodic billing statement is to be sent to the user.

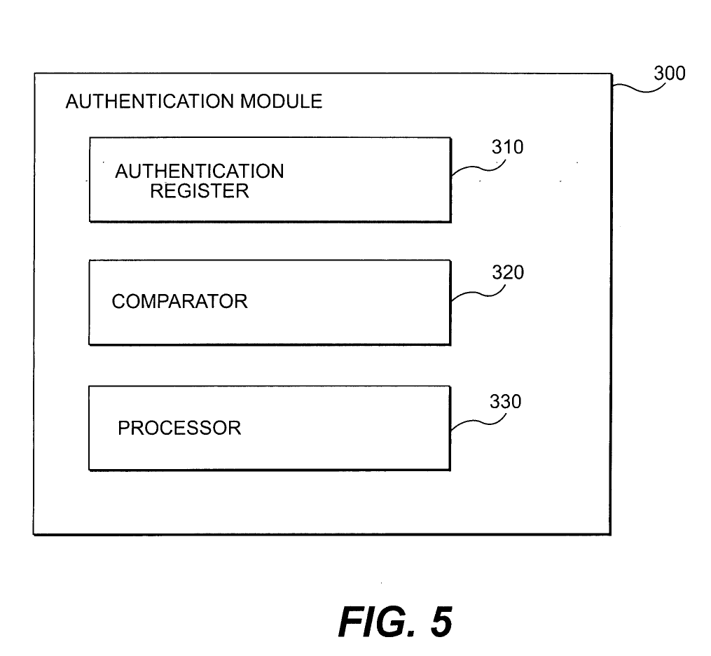

FIG. 5 is a block diagram of the authentication module 300. The authentication module 300 includes authentication register 310, comparator 320, and processor 330. In operation, when the switch 110 receives a call, which is determined to be a non-emergency call, the switch 330 prompts the user, at either the cellular telephone 150 or the mobile telephone 130, to enter a user-specific authentication number. The prompt may be a computer-generated voice message, a text message, a graphical message, or an iconic message, for example. The user-specific authentication number may be a seven-digit number, for example. The register 310 records identification information from the calling device (e.g., from the cellular telephone 150 or the mobile telephone 130). The identification information may be an equipment identification number associated with the cellular telephone 150 or the mobile telephone 130, the phone number of the calling device, or an identification number provided by the authentication device 120. Using this identification number, the processor 330 retrieves the user's assigned authentication number (assigned with installation of the authentication device 120 of FIG. 1A) from the user profile 510 and stores the retrieved authentication number in the register 310. The processor 330 also sends a signal to the billing module 200 to initiate the billing function of the switch 110. When received at the switch 110, the user-provided authentication number is also stored in the authentication register 310. The comparator 320 then compares the user-supplied authentication number and the retrieved authentication number, and if the two numbers match, the processor 330 signals that call processing may continue. The signaling includes sending a prompt to the user to enter the phone number of the call recipient.

In the case of a call from the cellular telephone 150, the authentication module 300 may additionally send a verification signal to the authentication device 120 to verify that the authentication device 120 is installed. The authentication module 300 would then wait for a return verification signal before proceeding with the call connection.

Returning to FIG. 3, in a wireless environment, such as shown in FIGS. 1A and 1B, there may be a need to locate users who place distress, or emergency (e.g., 911), calls. These emergency calls are used to gain rapid access to local authorities and emergency service centers. If a user places an emergency call from a wired device, such as the mobile telephone 130, locating that user is easy using call tracing procedures. Users calling from wireless devices such as the cellular telephone 150 are more difficult to locate.

The CellNet system 100 solves the problem of wireless user location by creating an identification number based on the current position of the user in the wireless environment. Within the switch 110, an emergency call processor 700 uses the telephone number of the cellular telephone 150, and other cell and network identity information to generate an identification number, which is then used to route the call to an emergency service center. The identification number includes position data available from the base station where the call origination is received. Optionally, for cellular telephones equipped with GPS technology, the switch 110 may receive the GPS-recorded position of the cellular telephone. As an example, the location information received from a base station of the cellular network 155 may be coded in hexadecimal. The switch emergency call processor 700 converts the hexadecimal number to binary coded decimal (BCD) and uses this number as an indication of the user's location.

Following is an example of the data conversion used by the emergency call processor 700 to convert the hexadecimal location data received from the base station to a dialed number for emergency callers. The data received could be as shown in the following table in which the base station receives the location of a user with cell ID granularity. The emergency call processor 700 converts the data as shown in the table.

| FIELD | RESULTING NUMBER OF DIGITS |
|---|---|
| Mobile Country Code | Up to 3 |
| Mobile Network Code | Up to 3 |
| Location Area ID | Up to 3 |
| Cell ID | Up to 3 |

The numbers produced from the conversion yields a unique twelve-digit number identifying that cell in the CellNet system 100.

If the call from the cellular telephone 150 or the mobile telephone 130 is an emergency call, the switch 110 bypasses the normal authorization and billing routines and, after establishing the user's location (if required), connects the user to the nearest appropriate emergency call servicing center.

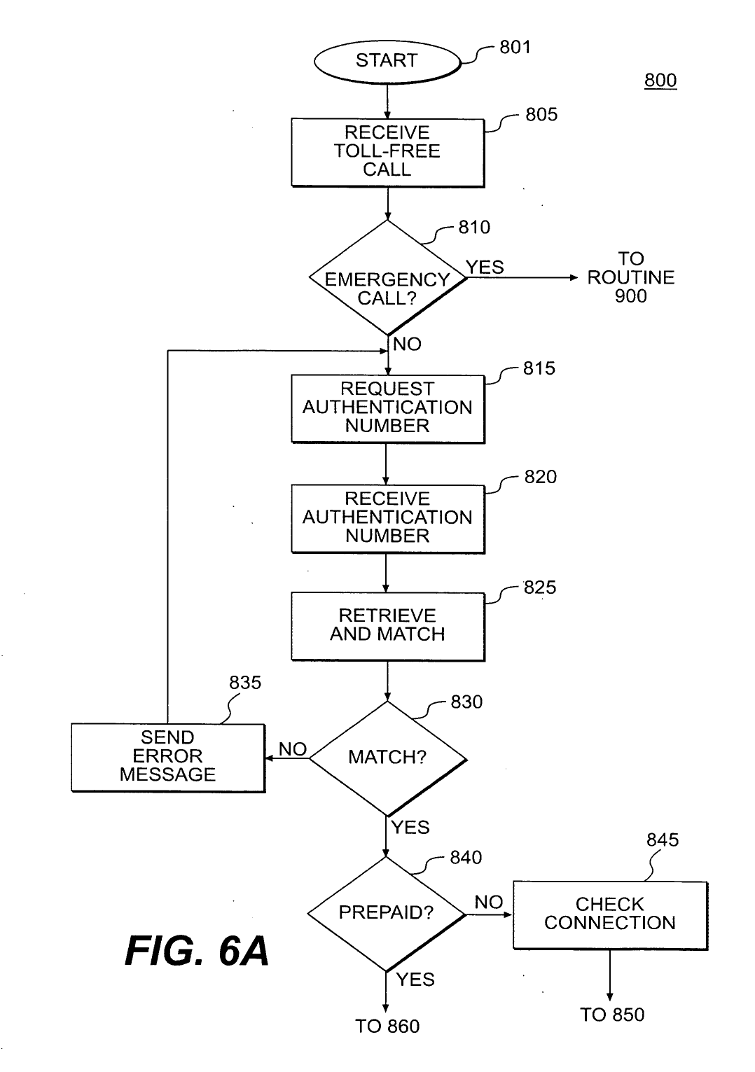

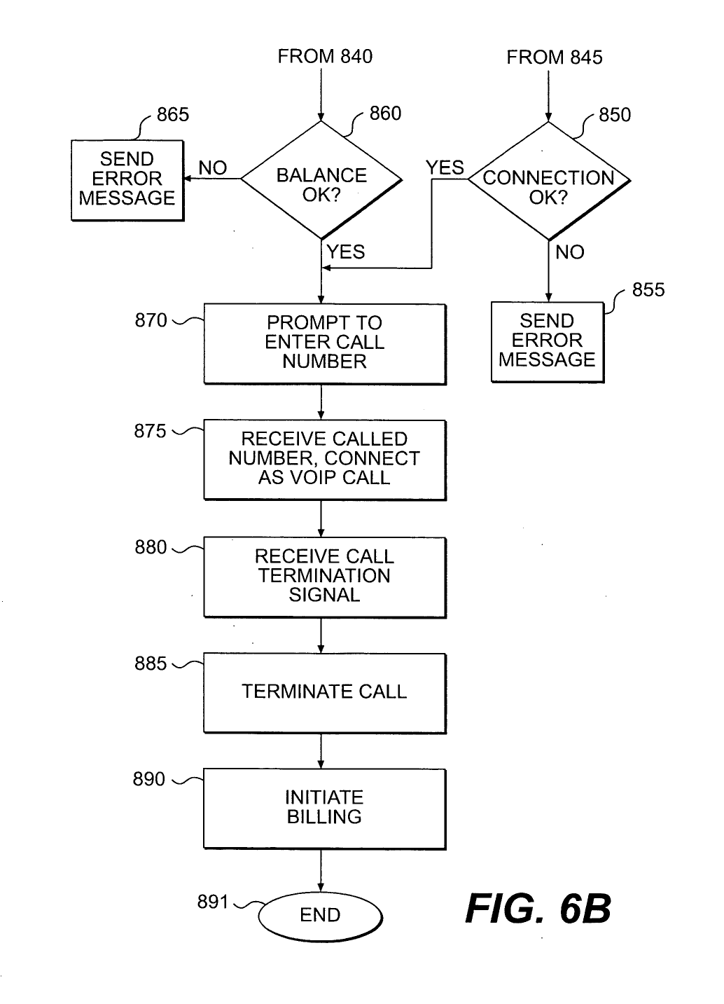

FIGS. 6A and 6B illustrate a flowchart of a call process 800 at the switch 110 of FIGS. 1A and 1B. The process 800 starts with start block 801. In block 805, the switch 110 receives a toll-free number call from a user. The call may be placed from the cellular telephone 150 or the mobile telephone 130, for example. In block 810, the I/O processor 400 determines if the received toll-free call is an emergency call or a normal call. The I/O processor module 400 may employ several means for determining if the call is an emergency call. If the received toll-free call is an emergency call, processing proceeds to emergency call routine 900. If the received toll-free call is not an emergency call, processing proceeds to block 815, and the switch 110 sends a prompt to the user to enter the user's authentication number. In block 820, the switch 110 receives the user's authentication number. Note that the used could, at this point in the call process 800, also initiate an emergency call by entering the appropriate digits (e.g., 911 in the United States) after the prompt, and hitting a “send” button on the cellular telephone 150. In blocks 825 and 830, the comparator 330 executes an authentication comparison routine in which the user's authentication number as extracted from the user information database 500 is compared to the received authentication number.

In block 830, the comparator 330 determines if the authentication numbers match. If the authentication numbers do not match, the call process 800 moves to block 835 and the switch provides an error message (text or voice) to the user. The call process 800 then returns to block 815.

In block 830, if the comparator 330 determines that the authentication numbers match, the call process 800 continues to block 840, and the switch 110 determines if the user has a prepaid calling plan. If the user does not have a prepaid calling plan, the call process 800 optionally proceeds to blocks 845 and 850, and the switch 110 executes a connection verification routine to verify connection of the authentication device 120 so that the user may be billed for the pending VoIP call. In block 845, the connection verification routine may consist of sending a signal to the user's authentication device 120 and receiving a return signal. In block 850, if the verification fails, the call process 800 proceeds to block 855 and send an error message (text or voice) to the user indicating a problem with the authentication device 120 connection. The call process 800 then proceeds to block 891 and ends. However, if in block 850, the verification is successful, the call process 800 proceeds to block 870.

If optional steps 845-855 are not executed (for example, as would be the case with the CellNet system 100′ of FIG. 1B), then the process 800 proceeds to block 870.

In block 840, if the user has elected a prepaid calling plan, the call process proceeds to block 860 and the CPM 600 determines if the user's prepaid account balance is sufficient to place the VoIP call. The determination of sufficient account balance may be based on a projected cost per minute, regardless of the call destination and any non-time related charges that may occur. Thus, for example, the CPM 600 may determine that the user's account balance is sufficient if the balance is enough to pay for two minutes of VoIP airtime. In block 860, if the CPM 600 determines that the account balance is insufficient, the call process 800 proceeds to block 865, and the switch 110 sends an error message (text or voice) to the user indicating an insufficient balance. The call process 800 then proceeds to block 891 and ends. At this point, the user can reestablish a sufficient account balance and again attempt to place the call.

In block 860, if the account balance is sufficient, the call process proceeds to block 870.

In block 870, the switch 110 prompts the user to enter the destination address (e.g., the number of the called party). In block 875, the switch 110 receives the number to be called, optionally converts the call to VoIP, completes the call connection routine, and connects the user to the called party using VoIP from the switch 110 to the called party.

In block 880, the switch 110 receives a call termination signal. The call termination signal could be generated by the user pressing an “end” button on the cellular telephone 150, an “off” button on the mobile telephone handset 131, or by the timer in the CPM 600 indicating a zero balance in the user's prepaid account. In block 885, the switch 110 completes a call termination routine. The call process 800 then proceeds to block 890 and the billing system 200 generates a call detail record and, for prepaid accounts, debits the user's prepaid account. The call process then proceeds to block 891 and ends.

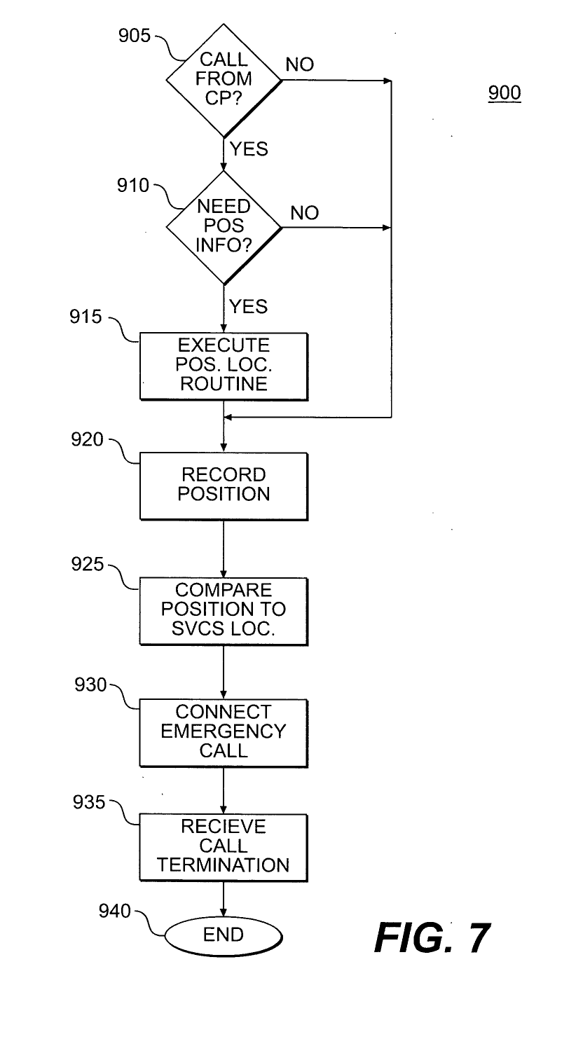

FIG. 7 is a flowchart illustrating emergency call processing routine 900 at the switch 10. In block 400, the I/O processor module 400 determines if the emergency call is from the cellular telephone 150. If the emergency call is not from the cellular telephone 150, the routine 900 proceeds to block 920. Otherwise, the routine 900 proceeds to block 910 and the emergency services module 700 determines if position location information is needed. If position information is not needed, the routine 900 proceeds to block 920. If position information is needed, the routine 900 proceeds to block 915 and the emergency services module 700 executes a position location routine. The position location routine may consist of obtaining GPS information form the cellular telephone 150, or executing a location algorithm such as described above.

In block 920, the position of the user is recorded in the emergency services module 700. Next, in block 925, the user's location is compared to locations of emergency service providers. In block 930, the emergency services module 700 initiates a call connection to the appropriate emergency services center. In block 935, the emergency services center receives a call termination signal, and terminates the emergency call. In block 940, the routine 900 ends.

1. A cellular-Internet communications system, comprising:
a cellular-Internet switch, wherein cellular-originated telephone calls are received;
means for routing the received cellular-originated telephone call as a Voice over Internet Protocol (VoIP) call;
an authentication device, wherein a cellular telephone is assigned an authentication number, the authentication providing means for billing a user for the VoIP call; and
a billing system, wherein time spent on the VoIP call is received and the user is billed.

2. The system of claim 1, further comprising:
means for converting a received cellular telephone call into a VoIP call
means for receiving a call from one of a cordless telephone and a wired telephone; and
means for converting the call from the cordless telephone and the wired telephone into the VoIP call.

3. The system of claim 1, wherein the authentication device comprises one of a router, a personal computer, a smart card, and a software program.

4. The system of claim 1, wherein the authentication device is coupled to the cellular-Internet switch using an Ethernet connection.

5. The system of claim 1, wherein the cellular-Internet switch comprises an emergency call module, comprising:
means for recognizing cellular call as an emergency call;
means for locating the cellular telephone making the emergency call; and
means for connecting the cellular call to a nearest emergency service provider.

6. The system of claim 1, wherein the billing system, comprises:
a prepaid calling module; and
a bill generation module.

7. The system of claim 6, wherein the prepaid calling module, comprises:
a data management module; and
one or more prepaid calling plans.

8. The system of claim 6, further comprising a call processing module (CPM) coupled to the billing system, the CPM comprising:
means for determining a pre-paid account for the user;
means for timing a length of the VoIP call;
means for indicating an impending pre-paid account zero balance to the user; and
means for terminating the VoIP call when the pre-paid account reaches zero.

9. The system of claim 8, wherein the CPM further comprises means for indicating a pre-paid account balance remaining to the user prior to connecting the VoIP call.

10. The system of claim 1, wherein the authentication device, comprises:
an authentication register that stores a user-provided authentication number and a retrieved authentication number;
a comparator that determines if the user-provided authentication number matches the retrieved authentication number; and
processor logic that verifies a connection to the authentication device.

11. A cellular-Internet communications system, comprising:
means for receiving a cellular telephone call and converting the received cellular telephone call to a packetized signal capable of transmission over the Internet as a VoIP call;
means coupled to the receiving and converting means for authenticating the received cellular telephone call; and
means for billing a user for the VoIP call.

12. The cellular-Internet communications system of claim 11, further comprising:
means for recognizing the received cellular telephone as an emergency call;
means for locating a user making the received cellular telephone call; and
means for connecting the user to an emergency services center.

13. The cellular-Internet communications system of claim 11, further comprising means for receiving a telephone call from a cordless telephone and converting the received cordless telephone call to a VoIP call.

14. The cellular-Internet telecommunications system of claim 11, wherein the billing means comprises prepaid billing means.

15. A method for placing a Voice over Internet Protocol (VoIP) call, comprising:
receiving a cellular-originated telephone call;
receiving an authentication number from a user making the cellular-originated telephone call;
verifying the authentication number, and if the authentication number is verified;
routing the cellular-originated telephone call as a VoIP call and transmitting the VoIP call to a destination address.

16. The method of claim 15, further comprising generating a billing record for the VoIP call.

17. The method of claim 16, wherein the VoIP call is placed as a prepaid calling plan call.

18. The method of claim 15, further comprising:
recognizing a cellular telephone call as an emergency call;
locating the user;
comparing the user location to locations of emergency service centers; and
connecting the user to an appropriate emergency service center.

19. The method of claim 15, further comprising:
receiving a telephone call from a cordless telephone;
receiving an authentication number from a user making the cordless telephone call;
verifying the authentication number, and if the authentication number is verified;
converting the cordless telephone call to a VoIP call and transmitting the VoIP call to a destination address.

20. A cellular-Internet communications system, comprising:
means for receiving a cellular telephone call and converting the received cellular telephone call to a packetized signal capable of transmission over the Internet as a VoIP call;
means for authenticating the received cellular telephone call; and
means for billing a user for the VoIP call.

21. The cellular-Internet communications system of claim 20, further comprising means for receiving a telephone call from a cordless telephone and converting the received cordless telephone call to a VoIP call.

22. The cellular-Internet telecommunications system of claim 20, wherein the billing means comprises prepaid billing means.
